(19) United States
(12) Patent Application Publication
(10) Pub. No.: US 2008/0011128 A1
(43) Pub. Date: Jan. 17, 2008

(54) Socket and fastener driving assembly using same

(76) Inventor: John F. Stephens, Ellettsville, IN (US)

Correspondence Address: John F. Stephens, 7097 W. Walker Lane, Ellettsville, IN, 47429, US

(21) Appl. No.: 11/485,763

(22) Filed: Jul. 13, 2006

(51) Int. Cl. B25B 13/00

(52) U.S. Cl. 81/124.2

(57) ABSTRACT

A socket includes a socket body having a first end configured to mate with a complementary portion of a driving tool, and a second end. The socket body includes at least one slot extending in a direction aligned with an axis of the socket body, and a fastener cradle configured to inhibit non-axial displacement of a fastener position within the at least one slot during driving of the fastener. A fastener driving assembly includes at least one socket having a fastener cradle configured to inhibit non-axial displacement of a fastener positioned in at least one slot of the socket body, and a driving tool.

### TECHNICAL FIELD

The present disclosure relates generally to tools for driving fasteners and the like, and relates more particularly to a socket having a fastener cradle configured to inhibit displacement of a fastener driven with said socket.

### BACKGROUND

A wide variety of motorized and manually driven tools for driving fasteners are known in the art. Box wrenches, hex wrenches, screwdrivers, etc., and various motorized apparatuses are employed across the broad spectrum of technical areas where fasteners are used. “Socket” wrenches and various motorized socket-driving tools are widely used to provide a relatively rapid and convenient means of driving fasteners, fastener nuts and similar articles. A conventional socket consists of a cylindrical body having an orifice configured to receive the article to be driven or a portion thereof. Such sockets also typically include an aperture or protrusion opposite the orifice such that the socket may be coupled with a driving member for applying a torque to rotate the socket when a fastener or fastener nut is positioned therein. The specialized head shape of certain types of fasteners, however, such as eyebolts, hooks, T-bolts and the like, have required a unique type of socket to accommodate their shape, introducing a new set of challenges.

One type of socket adapted for driving eyebolts and similar fasteners employs a slot configured to receive the head of an eyebolt or the like such that rotation of the socket may impart rotation to the fastener to drive the same into or out of a substrate. While such socket designs offer a measure of improvement over attempting to manually drive such fasteners, a problem that continues to plague attempts at efficient and reliable driving of eyebolts and similar fastener types relates to the tendency for the head of the fastener to slip out of a desired engagement with the driving socket In particular, it is common during driving of eyebolts and the like for a driven fastener to slip to one side within the socket, e.g. twisting or sliding in directions not aligned with the fastener's shaft axis, frustrating the user and slowing the operation.

U.S. Pat. No. 6,729,210 to Morris is directed to a driver for eyebolts and hooks which is configured via a longitudinal slot to be positioned about such a fastener to drive the same. A set screw is installed in a hole in a sidewall of the driver such that the set screw may be used to releasably engage and secure the eyebolt in the slot. While Morris provides one means of addressing displacement of a fastener during driving, the design and strategy are both relatively complex. A user must position the fastener within the slot, then tighten the set screw with a separate tool, drive the fastener, then finally disengage the set screw to remove the driving tool. Excessive time, effort and the use of extra tools are shortcomings attendant to Morris' design.

The present disclosure is directed to one or more of the problems or shortcomings set forth above.

### SUMMARY OF THE INVENTION

In one aspect, the present disclosure provides a socket for use in driving a fastener. The socket includes a body having a first end and a second end. The body defines an axis extending between the first and second ends and passing through a center of each of the first and second ends. The body further includes at least one slot extending in a direction aligned with the axis. The at least one slot includes an open end disposed at the second end of the body, and a closed end disposed between the first and second ends of the body. The body further includes a fastener cradle configured to inhibit non-axial displacement of a fastener positioned within the at least one slot during driving of the fastener.

In another aspect, the present disclosure provides a fastener driving assembly including a driving tool and at least one driven member that includes a socket having a body with at least one slot configured to receive a fastener and inhibit rotation thereof, and a fastener cradle configured to inhibit non-axial displacement of a fastener positioned in said at least one slot during driving of the fastener.

In still another aspect, the present disclosure provides a method of driving a fastener that includes positioning a fastener within at least one slot of a socket. The method further includes inhibiting the fastener from non-axial displacement from the at least one slot via a fastener cradle of the socket, including a step of contacting a head portion of the fastener with the fastener cradle. The method still further includes rotating the socket with the fastener positioned therein via a driving member.

### BRIEF DESCRIPTION OF THE DRAWINGS

FIG. 1 is a perspective view of a socket according to one embodiment of the present disclosure;

FIG. 2 is a sectioned side view taken along line 2-2 of FIG. 1;

FIG. 3 is a diagrammatic side view of a fastener driving assembly utilizing the socket of FIG. 1;

FIG. 4 is a perspective view of a socket according to another embodiment of the present disclosure;

FIG. 5 is a sectioned side view taken along line 5-5 of FIG. 4; and

FIG. 6 is a diagrammatic side view of a socket similar to the socket of FIG. 4.

### DETAILED DESCRIPTION

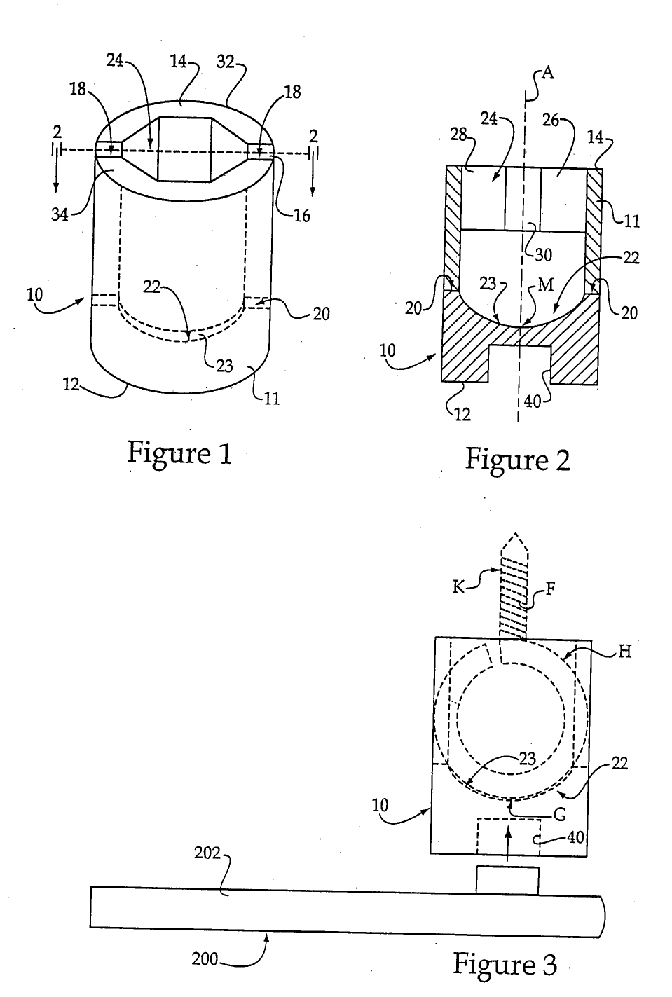

Referring to FIG. 1, there is shown a socket 10 according to one embodiment of the present disclosure. Socket 10 may comprise a driven member having a body 11 with at least one slot 18 configured to receive a fastener and inhibit rotation of the same during driving of the fastener with socket 10. Body 11 may further include a fastener cradle 22 configured to inhibit non-axial displacement of a fastener positioned within the at least one slot 18 during driving of the fastener, as described herein. Body 11 includes a first end 12 and a second end 14. In one embodiment, first end 12 may be configured to mate with a complementary portion of a driving tool such as a conventional socket wrench 202 or other driving member, shown in FIG. 3. To this end, body 11 may include either of an orifice or a protrusion to facilitate mating with the complementary portion of the driving member. Socket 10 may comprise one component of a multi-piece fastener driving assembly 200, also shown in FIG. 3. In some embodiments, socket 10 may be packaged for use with a plurality of other, similar sockets, potentially also including wrench 202 or a similar device. It should be appreciated, however, that socket 10, and the other socket embodiments described and contemplated herein, need not comprise a socket in the sense of a conventional cylindrical member useful only in conjunction with a separate wrench or other driving member. In other words, the sockets contemplated in the present disclosure might comprise a part of a unitary driving tool having a handle, motorized driver, etc. that is coupled to or formed integrally therewith. The present disclosure is considered to provide substantial improvements in efficiency and fastener driving reliability over known designs.

Embodiments are contemplated wherein the at least one slot 18 comprises a single slot extending across body 11. In one practical implementation strategy, however, two slots 18 will be provided which are oppositely positioned in body 11 and extend longitudinally therein, having open ends at second end 14 and having closed ends 20 positioned between first and second ends 12 and 14. Closed ends 20 may be positioned approximately at the same longitudinal position as fastener cradle 22. In one embodiment, fastener cradle 22 may include an arcuate surface 23 extending between closed ends 20 and configured to engage with a complementary arcuate portion of a fastener head, as described herein.

Referring also to FIGS. 2 and 3, socket 10 may include an orifice 24 in second end 14, communicating with slots 18. In one embodiment, orifice 24 may be configured to engage with a polyangular fastener head, nut or the like. To this end, socket 10 may include a plurality of inwardly facing contact surfaces, for example planar surfaces, disposed at a longitudinal position of body 11 that is between fastener cradle 22 and second end 14. Surfaces 26, 28 and 30 may be configured in socket 10 in a manner similar to that of a conventional socket in that they will allow socket 10 to be engaged with fasteners and fastener components such as nuts in a conventional manner. Rather than several planar surfaces, a plurality of ridged surfaces or the like such as are commonly used in other socket types may be provided.

Socket 10 may further include outer peripheral walls 32 and 34 having surfaces 26, 28 and 30 formed on an inner side thereof, walls 32 and 34 extending radially about a longitudinal axis A of socket 10 which intersects a center of each of first and second ends 12 and 14. In one embodiment, walls 32 and 34 will extend between slots 18 continuously and uninterrupted by additional slots or other features. In other words, body 11 may be configured with slots 18, having open sides at a periphery of body 11, but otherwise defining a continuous periphery. Embodiments having more than one set of slots are also contemplated. Such versions may not be preferred, however, as additional slots in walls 32 and 34 may tend to reduce the fracture strength of body 11 and thus render it less suitable for driving certain fasteners, and in certain environments such as those requiring a fastener to be driven into a particularly hard substrate. In a preferred embodiment, angular edges associated with closed ends 20, and for that matter all edges of slots 18, may be modified to include radii at such edges for improving strength, as well as aesthetics and comfort of use of socket 10.

Turning in particular to the design for fastener cradle 22, arcuate surface 23 may extend between closed ends 20, defining an arcuate line segment along said surface which intersects axis A at approximately a midpoint M of the arcuate line segment. In a practical implementation strategy, a fastener F, shown in phantom in FIG. 3, may be positioned in slots 18 for driving. Fastener F may include a shaft portion K, having a shaft width and defining a fastener axis (not shown), and a head portion H having a terminal end G. Contacting of at least terminal end portion G with surface 23 will provide inhibition of displacement of fastener F in directions not aligned with its axis. In other words, interaction of head portion H, and in particular terminal end G with surface 23, will inhibit slipping of fastener F in a side-to-side manner during driving. The displacement of fastener F which is sought to be inhibited may be thought of as having at least two components, a rotational component and a linear component. In other words, it will generally be desirable to prevent fastener F from rotating non-axially, i.e. clockwise or counterclockwise in the plane of the page in FIG. 3, and it will generally be desirable to also prevent fastener F from sliding left to right relative to body 11 during driving, even if not rotating. Interaction between fastener cradle 22 and fastener F during driving will tend to prevent either of these types of displacement from occurring, resulting in efficient and reliable fastener driving without the need for a further engagement step such as via the use of a set screw, as in Morris.

The shape of surface 23 may be varied to accommodate different fastener head configurations, and the arcuate line segment defined by surface 23 may thus comprise a portion of a circle, or may have a different shape. In the embodiment shown in FIG. 3, surface 23 may be concave, however, and complementary to fastener F such that it contacts head portion H at a plurality of points. For different fastener types, surface 23 might instead by convex or have still another configuration. Further still, while in one practical implementation strategy, surface 23 may be fashioned to be complementary to the entire portion of a fastener head with which it is to contact, such a design is not critical so long as some greater inhibition of slipping, sliding, etc. is achieved over that which would be provided by a simple planar surface.

Body 11 may be metallic, such as hardened steel, and may be formed by casting, forging, machining or any other suitable process. Fastener cradle 22 may in turn be formed during initial manufacturing, but might also be formed by subsequent processing techniques. In one contemplated embodiment, cradle 22 may be formed by grinding an arcuate surface at the bottom of a slot which is formed in body 11 during initial casting. Forming radii on angular edge surfaces of body 11 may also be performed via a variety of machining techniques, as is common in the metal fabrication arts.

Slots 18 may each include a diameter, as measured in the, direction of curvature of walls 32 and 34, corresponding to the width of a fastener shaft positioned in socket 10. Referring in particular to FIG. 3, a fastener such as fastener F will have a shaft or shank width. It is common for the shaft width to be identical or similar to a width of head portion H, as such fasteners are typically made from a single piece of bent metallic rod. Because slots 18 are typically configured to substantially match the diameter of a selected fastener positioned therein, slots 18 will typically have a diameter corresponding to the shaft width of a given fastener. In one embodiment, socket 10 may be configured such that orifice 24 may receive fasteners and fastener components defining shaft widths identical to the shaft widths associated with fasteners received in slots 18. For instance, a socket that is a 9/16 inch socket may be configured for driving 9/16 inch eyebolts via slots 18, as well as 9/16 inch bolts or nuts via orifice 24 and its associated contact surfaces 24, 26 and 28. Such an embodiment may provide for further efficiency in design and use of sockets and sets of sockets according to the present disclosure.

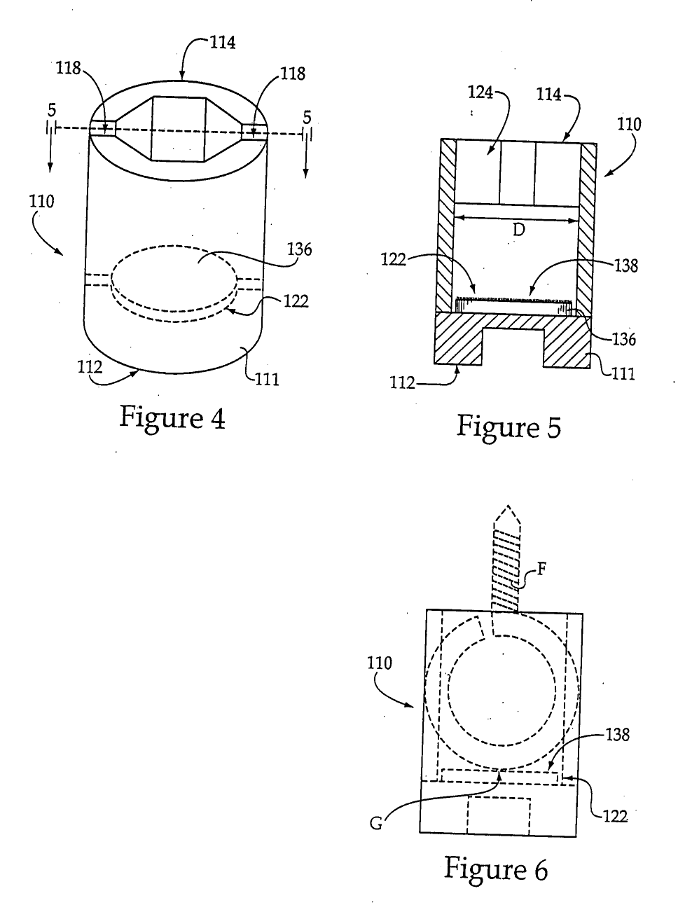

Turning to FIGS. 4-6, there is shown a socket 110 according to another embodiment of the present disclosure. Socket 1 10 is similar to socket 10, and might similarly comprise a portion of a fastener driving assembly (not shown), or might comprise a component of a unitary device, similar to the manner described above with regard to socket 10. Where contemplated for use with a separate driving member, a body 111 of socket 110 may be configured to mate with a complementary portion of a driving member. Body 111 may also include an orifice 124 which may be configured similarly to orifice 24 of socket 10.

The configuration of a fastener cradle 122 of socket 110, however, differs from that of socket 10. In particular, rather than a fastener cradle having an arcuate surface, socket 110 may include a fastener cradle that comprises an insert 136 positioned within a socket body 111. In socket 110, an orifice 124 may be positioned in a second end 114 and may define an inner diameter D of socket body 111. Insert 136 may include an outer diameter matched to inner diameter D, to enhance securing insert 136 in socket body 111. Insert 136 may be secured in socket body 111 by pressing, welding, soldering or by any other suitable means.

Insert 136 may further, comprise a roughened or otherwise irregular surface 138 oriented toward second end 114 of socket body 111. Surface 138 may be configured to frictionally interact with a terminal end G of a fastener head positioned in slots 118 of socket body 111. In one embodiment, insert 136 may comprise a discoidal body. Insert 136 may be metallic, and roughened surface 138 formed via a variety of processing techniques such as waffling, pressing, chemical etching or otherwise providing a surface having the desired frictional characteristics. Rather than an insert, however, it should be appreciated that friction surface 138 might comprise a coating or other surface treatment on body 111 to inhibit non-axial displacement of fastener F. In still another embodiment, insert 136 may comprise an elastomeric disk insert also having a friction surface 138 oriented toward second end 114, and configured to frictionally interact with a terminal end of a fastener head positioned in slots 118 by virtue of the material from which insert 136 is made, rather than by virtue of its surface characteristics formed by processing techniques.

### INDUSTRIAL APPLICABILITY

When a user desires to drive a fastener with socket 10, 110 and/or assembly 200, fastener F or another fastener type may be positioned in slots 18, 118, and the terminal end G of fastener F contacted with fastener cradle 22, 122. Engagement of a fastener within socket 10, 110 can provide at least three points of contact between fastener F and body 11, 111, one with each of slots 18, 118 and one with fastener cradle 22, 122.

Fastener F may be positioned such that shaft portion K extends partly into a pilot hole, for example, and fastener F rotated by rotating socket 10, 110. Rotation of fastener F will be achieved via a bearing of edges of slots 18, 118 against head portion H to rotate the same. When fastener F has been driven to a desired depth in a substrate (or has been removed at least partially from a substrate), socket 10, 110 may simply be disengaged by sliding socket 10, 110 out of engagement with fastener F.

The present disclosure provides substantial advantages over conventional methods such as placing a'screwdriver within an eyebolt or similar headed fastener and manually rotating the fastener. Similarly, the present disclosure obviates the need to use a separate set screw or other securing means to maintain the driven fastener in a desired orientation, providing significant improvements over relatively more sophisticated means of fastener driving.

The present description is for illustrative purposes only, and should not be construed to narrow the breadth of the present disclosure in any way. Thus, those skilled in the art will appreciate that various modifications might be made to the presently disclosed embodiment without departing from the intended spirit and scope of the present disclosure. For instance, while sockets 10 and 110 are contemplated to be formed with their respective slots 18, 118 opening to the sides of the corresponding socket bodies 11, 111, alternatives are contemplated. For instance, rather than slots having opening sides, sockets 10, 110 might be designed such that slots 18, 118 open only internally in the respective socket body 11, 111, such that the peripheral walls of the socket bodies are continuous and uninterrupted around the entire periphery of the respective socket body. Such a design might be applicable where it is desired to provide an especially robust socket. Other aspects, features and advantages will be apparent upon an examination of the attached drawing and appended claims.

What is claimed is:

1. A socket for use in driving a fastener comprising:
a body having a first end and a second end, said body defining an axis extending between said first and second ends and passing through a center of each of said first and second ends;
said body further including at least one slot extending in a direction aligned with said axis, said at least one slot including an open end disposed at the second end of said body, and a closed end disposed between the first and second ends of said body; and
said body further including a fastener cradle configured to inhibit non-axial displacement of a fastener positioned within said at least one slot during driving of the fastener.

2. The socket of claim 1 wherein said at least one slot comprises first and second oppositely positioned longitudinal slots, said body being configured to mate with a complementary portion of a driving member.

3. The socket of claim 2 wherein said body further comprises an orifice disposed in said second end and communicating with said first and second slots.

4. The socket of claim 3 wherein said body includes a longitudinal dimension between said first and second ends, and said orifice comprises a polyangular orifice defining a plurality of inwardly facing contact surfaces disposed between said second end and said fastener cradle.

5. The socket of claim 3 wherein said body further comprises first and second opposite peripheral walls, each extending continuously between said first and second slots and about said axis.

6. The socket of claim 5 wherein said orifice is configured to receive a polyangular fastener component defining a fastener shaft width, and wherein said slots each include a diameter corresponding to said fastener shaft width.

7. The socket of claim 5 wherein said fastener cradle comprises an insert positioned within said body.

8. The socket of claim 7 wherein said orifice extends between said second end and said fastener cradle and defines a body inner diameter, said insert having an outer diameter matched to said inner diameter.

9. The socket of claim 8 wherein said fastener cradle comprises a discoidal insert.

10. The socket of claim 9 wherein said fastener cradle comprises a metallic disc insert having an irregular surface oriented toward the second end of said body and configured to frictionally interact with a terminal end of a fastener head positioned in said slots.

11. The socket of claim 9 wherein said fastener cradle comprises an elastomeric disc insert having a surface oriented toward the second end of said body and configured to frictionally interact with a terminal end of a fastener head positioned in said slots.

12. The socket of claim 5 wherein said fastener cradle comprises an arcuate cradle surface configured to abut an arcuate portion of a fastener head positioned within said slots.

13. The socket of claim 12 wherein said arcuate cradle surface extends across a majority of a width of said body from a closed end of the first slot to a closed end of the second slot.

14. A fastener driving assembly comprising:
a driving member; and
at least one driven member comprising a socket having a body with at least one slot configured to receive a fastener and inhibit rotation thereof, and a fastener cradle configured to inhibit non-axial displacement of-a fastener positioned in said at least one slot during driving of the fastener.

15. The fastener driving assembly of claim 14 wherein:
said body defines a longitudinal central axis extending between first and second ends thereof;
said at least one slot comprises an open end disposed at the second end of said body, and a closed end; and
said fastener cradle comprises an arcuate surface disposed at said closed end and defining an arcuate line segment intersecting said longitudinal axis at a midpoint of said arcuate line segment.

16. The fastener driving assembly of claim 1,5 wherein said body defines an outer periphery, said at least one slot comprises a first and a second longitudinal slot extending along opposite sides of said body and having open sides at said outer periphery, and wherein the arcuate surface of said fastener cradle extends between closed ends of said first and second slots.

17. The fastener driving assembly of claim 14 Wherein said body comprises a first end and a second end, said at least one slot having an open end at the second end of said body, and wherein said fastener cradle comprises a friction surface oriented toward the second end of said body.

18. The fastener driving assembly of claim 17 wherein said fastener cradle comprises an insert whereupon said friction surface is disposed.

19. A method of driving a fastener comprising the steps of:
positioning a fastener within at least one slot of a socket;
inhibiting the fastener from non-axial displacement from the at least one slot via a fastener cradle of the socket, including a step of contacting a head portion of the fastener with the fastener cradle; and
rotating the socket with the fastener positioned therein via a driving member.

20. The method of claim 18 wherein the fastener comprises an end portion having a rounded terminal end, and wherein the inhibiting step comprises inhibiting non-axial displacement of the fastener via a step of contacting the rounded terminal end with a surface of the fastener cradle configured to inhibit non-axial displacement of said fastener.
